(19) United States
(12) Patent Application Publication
(10) Pub. No.: US 2003/0028611 A1
(43) Pub. Date: Feb. 6, 2003

(54) Multi-task, multi-location networking system

(76) Inventors: John G. Kenny, Aliso Viejo, CA (US); Kenneth J. Kenny, Aliso Viejo, CA (US); John G. Kenny JR., Aliso Viejo, CA (US); Patrick A. Nerad, Lomita, CA (US)

Correspondence Address: ALBERT O COTA, 5460 WHITE OAK AVE, SUITE A-331, ENCINO, CA, 91316, US

(21) Appl. No.: 09/910,548

(22) Filed: Jul. 23, 2001

(51) Int. Cl. G06F 15/16

(52) U.S. Cl. 709/217

(57) ABSTRACT

A multi-task, multi-location networking system (10) which operates in combination with an internet service provider (42) known as Globalink Access^{SM} to allow persons remotely located in a hotel room, to easily and conveniently request a variety of data provided by the hotel and Globalink Access^{SM}. The system (10) consists of three major elements: a central data-processing subsystem (12) that is linked to a remote data-processing subsystem (40) by means of the Internet and a software program (60). The subsystem (12) is designed to receive, process and transmit the requested data to the remote data-processing subsystem (40) from where the requested data is viewed on a computer terminal (52).

### TECHNICAL FIELD

The invention pertains to the general field of computer services provided by multi-room facilities such as a hotel and more particularly to a hardware/software networking system which operates in combination with an internet service provider to allow hotel guests to access various data directly from their rooms.

### BACKGROUND ART

Throughout the world hotels and motels are utilized by all types of people, from all walks of life. Motels are used by families on vacation, individuals on business trips and even for simple weekend getaways.

While hotels are available that offer a large variety of amenities and services, such as “all-suites”, recreation and exercise facilities, chauffeured transportation and concierge services, many of these extras are usually only available at exclusive, expensive hotels. For those people who either do not need these services, or who can not afford them, there are other hotels with less services at more moderate prices.

Regardless of whichever type of hotel is used, there are concerns that are of importance to most every person who stays in the hotel. Some of the concerns are directly related to the hotel itself, such as security for the people staying there. Another concern, which is more personal in nature to the individual, is whether a hotel is able to provide adequate facilities for performing work, especially in the hotel room itself.

Due to the fact that hotel crimes have become more prevalent in recent years there are still many problems that are inherent to a person staying in a different locate, in un-familiar surroundings. Couple these problems with the ability of many people, including those with bad intentions, to enter and move freely about most hotels, the security risk increases substantially.

When considering a person's ability to work in a hotel room, it is surprising that with the prevalence of computers and other advanced technological devices, the majority of hotels today do not offer services or links to facilitate the use of these.

Obviously, a hotel should incorporate computers and computer-based services, such as internet access into the individual rooms. This would give the hotel and its staff the ability to provide better, more personalized security; improve currently-used services, such as room service and concierge; and to offer business people and others who need or enjoy using computers the ability to do so in the privacy of their own room. Additionally, from a hotel's standpoint, the ability to perform many daily functions related to the operation of the hotel could be expanding and significantly improved by providing hotel-wide, connected computers in every room.

A search of the prior art covering hardware and computer software programs for the hospitality industry did not disclose any patents that read directly on the claims of the instant invention. However, the following U.S. patents were considered related:

| PATENT NO. | INVENTOR | ISSUED |
|---|---|---|
| 5,708,780 | Levergood | 13 Jan. 1998 |
| 5,331,546 | Webber, et al | 19 July 1994 |
| 5,237,499 | Garback | 17 Aug. 1993 |

The U.S. Pat. No. 5,708,780 discloses a process for controlling and monitoring access to network servers. The process includes client-server sessions over the Internet involving hypertext files in which a client views a document transmitted by a content server with a standard browser. Each hypertext page contains links to other hypertext pages which the user may select to traverse. When the user selects a link that is directed to an access-controlled file, the server subjects the request to a secondary server which determines whether the client has authorization or a valid account. Upon such verification, the user is provided with a session identification which allows the user to access the requested file.

The U.S. Pat. No. 5,331,546 discloses a travel planner system which automatically constructs itineraries with available seats for a traveler's trip request. The system includes a check on whether a connecting flight distance exceeds that of a possible direct flight by a preset distance. The system finds travel fares by constructing sum-of-segments fares for each such itinerary which are valid under the applicable airline tariffs and rules; finds itinerary-with-fare combinations acceptable in terms of cost and convenience to the traveler in accordance with the travel policy of the traveler; and displays some of the itineraries by departure or arrival time.

The U.S. Pat. No. 5,237,499 discloses a computer-based system for processing travel requests directed to a specific venue from individual members of a group. The system includes a data base containing a venue file including information regarding the specific venue, a group member file for each individual member of the group, a travel policy file containing information on preselected vendors of various travel services, and a city code file containing codes corresponding to city airport locations. Data is entered and information is displayed to an individual group member making a travel request via a personal computer. A central processing unit (CPU) is in communication with the data base and with a plurality of airline systems. The CPU is programmed to select an individual group member itinerary for the specific venue which includes specific airline flights, hotel accommodations and rental car services.

For background purposes and as indicative of the art to which the invention relates, reference may be made to the following remaining patens found in the search:

| PATENT NO. | INVENTOR | ISSUED |
|---|---|---|
| 5,797,127 | Walker, et al | 18 Aug. 1998 |
| 5,715,314 | Andrew, at al | 3 Feb. 1999 |
| 5,270,921 | Hornick | 14 Dec. 1993 |
| 4,931,932 | Dalnekoff | 5 June 1990 |

### DISCLOSURE OF THE INVENTION

The multi-task, multi-location system is designed to provide a person located in a remote facility such as a hotel, motel, hospital, military complex and the like (hereinafter “hotel”) with the ability to receive various types of information which is accessed via an in-room computer terminal. The system is comprised of a central data-processing subsystem that is linked to a plurality of remote data-processing subsystems by an internet service provider known as Globalink Access.

The central data-processing subsystem is typically housed in a central location and includes the hardware and software necessary to operate the multi-task, multi-processing system. The system is monitored and system support is provided seven days a week and twenty-four hours per day.

The remote data processing subsystems are located within a hotel and include the hardware and software necessary to operate a plurality of computer terminals. Each hotel room is equipped with a computer terminal which can be activated at check-in.

Each hotel guest who selects to go online is provided with:

24-hour unlimited high-speed Internet access,

free Internet E-mail,

a 30-megabytes Internet locker,

in-room security,

internal hotel-wide messaging consisting of private messaging and public messaging including a 911 emergency notification,

a hotel service package which includes hotel information, concierge services, national and local advertising banners, and

laptop computer access.

In view of the above disclosure, the primary object of the invention is to provide the multi-task, multi-location networking system that consists of the central data-processing subsystem and the remote data processing subsystems.

The remote subsystems, which are preferably located in a multi-room facility such as a hotel, are linked to the central subsystem by Globalink Access an Internet service provider. From the remote subsystems, a user can access a variety of data provided by the hotel and by Globalink.

In addition to the primary object of the invention, it is also an object of the invention to produce a multi-task, multi-location networking system that:

allows existing system elements to be upgraded by newer state-of-the-art elements,

allows existing data to be easily deleted and new data to be easily added,

can be designed to accommodate the particular requirements of a facility where the system is installed,

is easily maintained,

improves the revenue per available room (REVPAR),

can transform ordinary hotel rooms into an Internet suite,

can increase hotel room sales, and

is cost effective.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a block diagram showing the basic subsystems which comprise the multi-task, multi-location networking system, namely, a central data processing subsystem which is linked through the Internet to a plurality of remote data processing subsystems, wherein one of the remote subsystem is shown as a hotel servicing a number of hotel rooms.

FIGS. 2A and 2B are block diagrams showing the multi-task, multi-location system in which the subsystems are designed with a maximum number of elements.

FIGS. 3A and 3B are block diagrams showing the multi-task, multi-location system in which several elements are combined into a single element to produce a system which includes a minimum number of elements.

FIG. 4 is a block diagram showing the flow-path of the system software program.

### BEST MODE FOR CARRYING OUT THE INVENTION

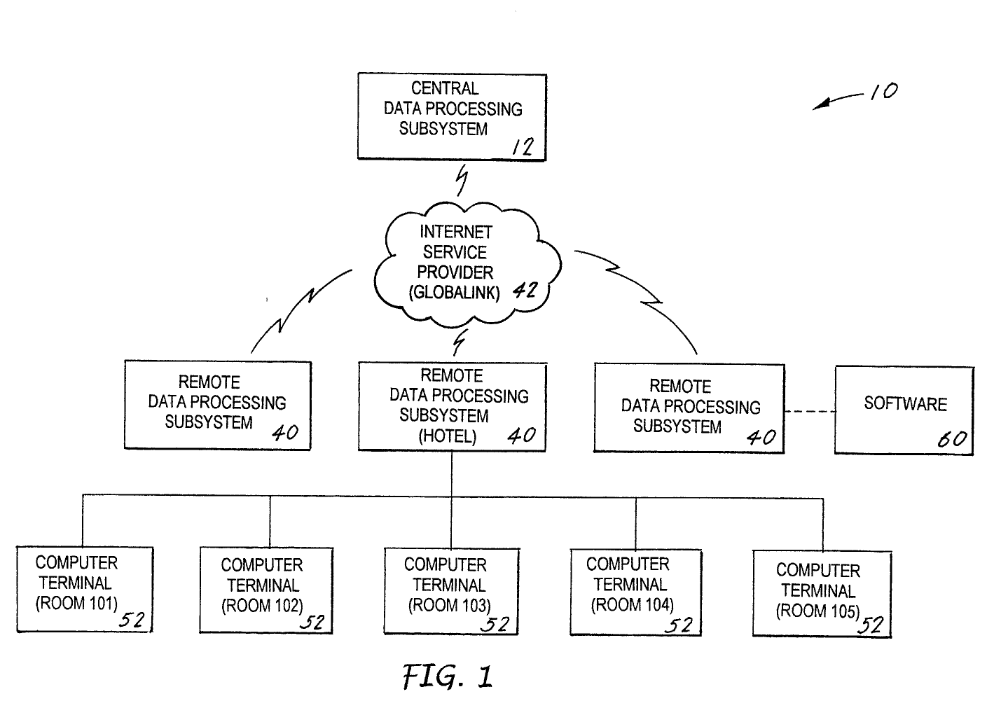

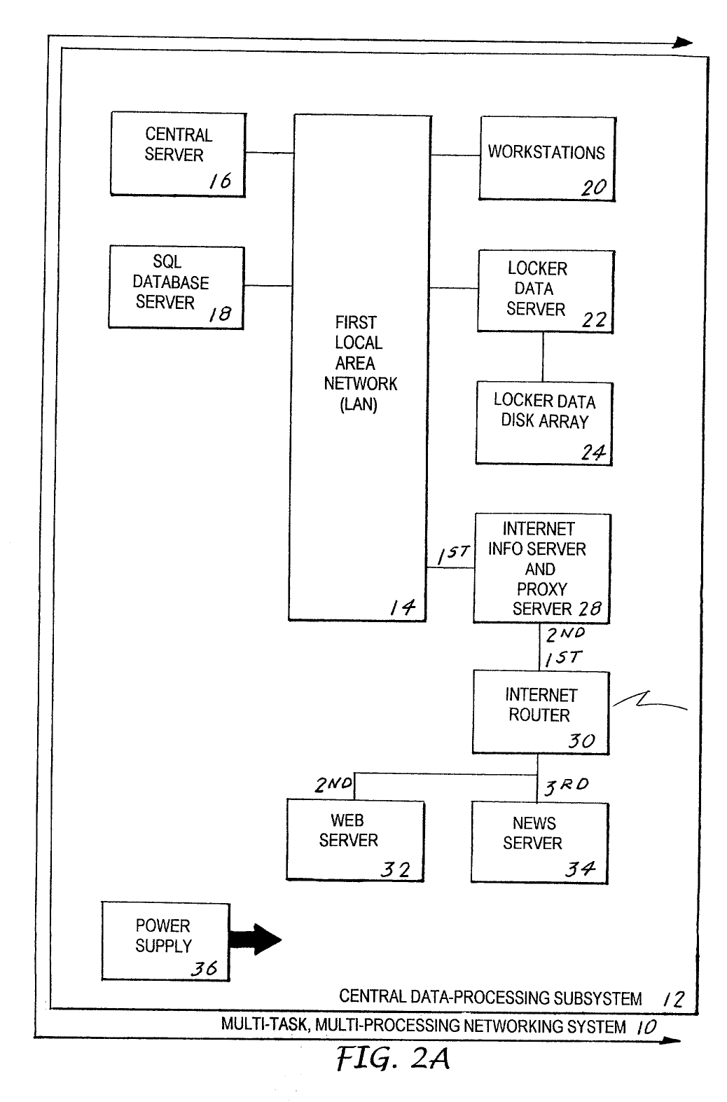

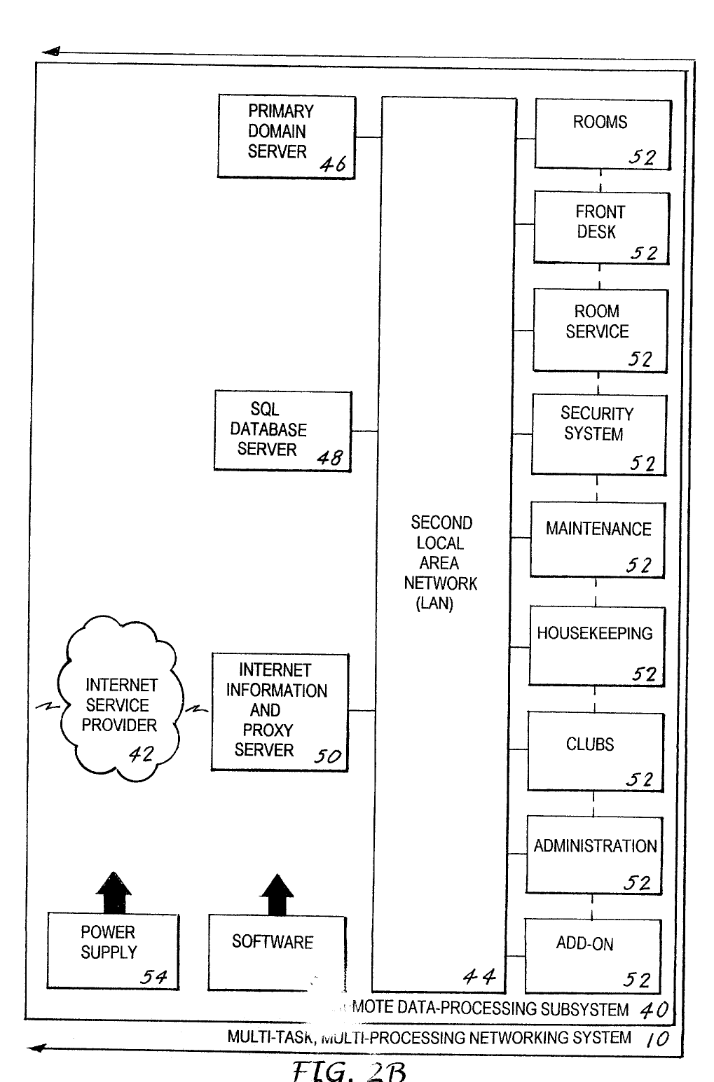

The best mode for carrying out the multi-task, multi-location networking system 10 is presented in terms of a preferred embodiment which is disclosed in two design configurations. In both design configurations the system 10, as shown in FIG. 1, is comprised of a central data processing subsystem 12, a plurality of remote data-processing systems 40 that are linked to the subsystem 12 through an internet service provider (ISP) 42, and a software program 60. For the instant invention the ISP is Globalink Access^{SM} which is accessed by the Internet Universal Resource Locator (URL) www.globalink.net. The system 10 is amenable for implementation in any multi-room location such as a user located in a hotel, a motel, a hospital, a military complex and the like. However, for brevity the description that follows will refer to only a hotel. In the first design, the system 10, as shown in FIGS. 2A and 2B, is implemented with a maximum number of discrete elements.

The central data-processing subsystem 12, as shown in FIG. 2A, is comprised of the following major elements: a first local area network (LAN) 14, a central server 16, a Structured Query Language (SQL) database server 18, a plurality of workstations 20, a locker data server 22 that operates in combination with a locker data disk array 24, a combination internet information server and proxy server 28, an internet router 30, a web server 32, a news server 34 and a power supply 36.

The first LAN 14 allows the plurality of computer terminals and other subsystem elements that reside in the central data processing subsystem 12, to share files. The first LAN 14, as well as a second LAN 44 used in the remote data-processing subsystem 40, are typically comprised of an Ethernet network which provides communication by radio frequency signals carried by a coaxial cable. The Ethernet used in the subsystem 14 operates on a broadband which modulates the Ethernet signal on a higher-frequency carrier to allow several signals to be carried simultaneously on a single coaxial cable. The control strategy of the Ethernet allows each computer terminal to determine if another terminal is transmitting. If so, it waits its turn to transmit. If two terminals inadvertently transmit at the same time, the collision is detected and they re-transmit one at a time.

The central server 16 is connected to the first LAN 14 and functions in combination with a computer terminal. The server 16 provides file access for other computer terminals that are implemented through the first LAN 14. For purposes of discussion, the computer terminals are defined as being desktop PC-type computers that operate on Windows NT and that are permanently installed in a hotel room.

The SQL database server 18, which is also connected to the first LAN 14 functions in combination with a computer terminal to store and administer the SQL database of the system 10.

The workstations 20 are each comprised of a computer terminal which is connected to the first LAN 14. The workstations 20 allow a user of the system 10 to connect and use the central data-processing subsystem. Each of the workstations 20 is typically comprised of a microcomputer having at least 32 megabytes of RAM, 2 gigabytes of disk capacity, a screen with graphics resolution of at least 800×600 pixels.

The locker data server 22 which is also connected to the first LAN 14 functions in combination with a computer terminal and a 30-megabyte locker data disk array. The combination allows a user's proprietary data to be stored, accessed and or changed by the user. Access to the stored data is by a password.

The combination Internet information server and proxy server 28, as shown in FIG. 2A, has a first connection and a second connection, wherein the first connection is connected to the first LAN 14 and the second is connected to the Internet router 30. The two servers provide the user controlled access to the Internet.

The Internet router 30 has a first, second and third connection, wherein the first connection is connected to the second connection on the combination internet information server and proxy server as shown in FIG. 2A. The router 30 provides the means by which the central data-processing subsystem interfaces with the Globalink Internet service provider. The router's second connection is connected to the Web server 32 and the third connection to the news server 34. The web server 32 provides the means by which, both local and external users of the system 10, can view system related web pages. The web pages are designed to provide both informational and advertising opportunities.

The news server collects and disseminates to a user current news events, weather and other newsworthy topics.

The remote data-processing system 40, as shown in FIG. 2B, allows the remotely located users to access requested data which is viewed on a computer terminal located in the hotel room. The subsystem 40 is connected to the central data-processing subsystem 42 via the ISP 42 as shown for visual convenience in FIG. 2B. The ISP referred to as Globalink Access^{SM} consists of a cooperative message-forwarding system that links computer networks throughout the world. Typically a hotel that subscribes to Globalink Access^{SM} pays a monthly fee, a usage fee or a revenue sharing fee. For the fee, Globalink Access^{SM} supplies the hotel with the hardware and software that enables the user in the hotel to connect to the Internet.

The remote data-processing subsystem 40, as shown in FIG. 2B, includes: a second local area network (LAN) 44, a primary domain server 46, an SQL data base server 48, a combination internet information server and proxy server 50, an information receiving computer terminal 52, a power supply 54 and the software program 60.

The second LAN 44 allows the plurality of computer terminals and other elements residing in the remote data-processing subsystem 40 to share files.

The primary domain server 46 is connected to the second LAN 44 and functions in combination with a computer terminal to provide administration over the remote data-processing subsystem 40. The SQL data base server 48, which is also connected to the second LAN 44 functions in combination with a computer terminal to store and administer the SQL database of the remote data-processing subsystem 40.

The combination Internet information server and proxy server 50 is also connected to the second LAN 44 and interfaces with the internet service provider 42. The combination servers 50 allow both local and external system users to view web pages related to the system 10.

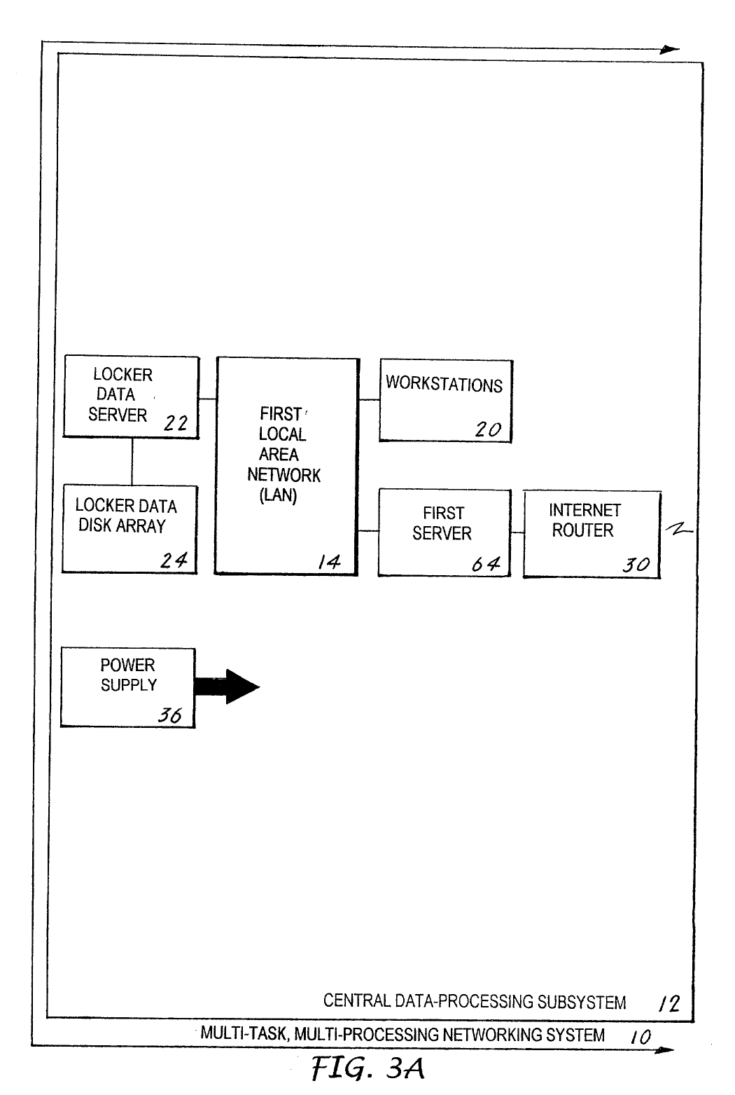

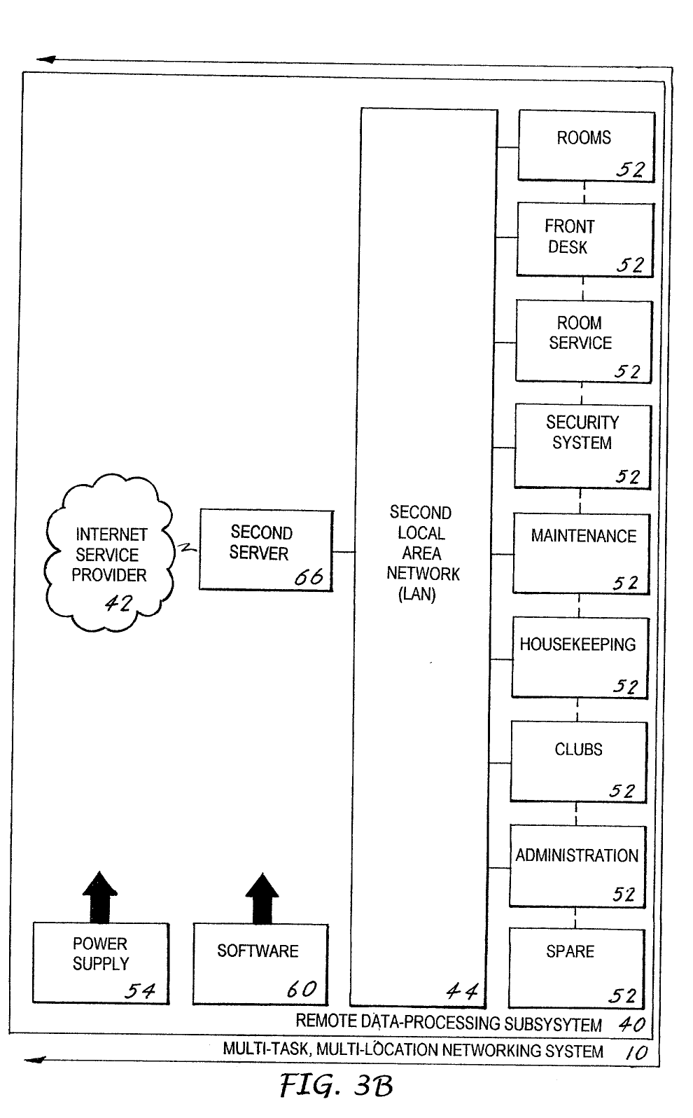

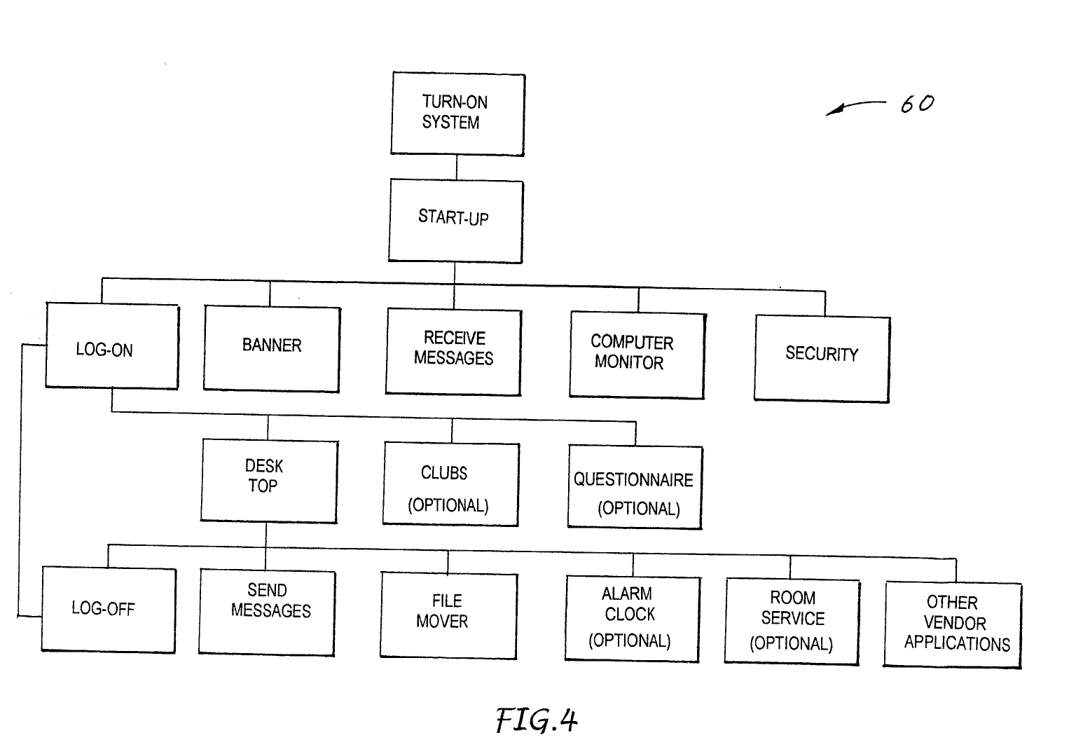

For explanatory purposes, as shown in FIGS. 2B and 3B, several information receiving computer terminals 52 are shown attached to the second LAN 44 to illustrate the various data that can be accessed by a user from their room. In reality, only one computer terminal 52 is located in each hotel room.

The plurality of user accessible data, as shown in FIG. 2B, is basically comprised of the following data, however as also shown in FIG. 2B in the last block, additional data can be added as needed:

Rooms—provides data pertaining to services that can be accessed directly from the hotel room, such as the Internet and other services provided by Globalink Access^{SM}.

Front Desk—provides data pertaining to future reservations, checkout times, baggage help etc.

Room Service—provides wake-up calls, restaurant menus and ordering instructions, laundry pick-up, secretarial services, personal grooming services, etc.

Security—provides services relating to personal security. For example, when a hotel guest places a request for a service or to alleviate a hotel room problem, the hotel person that is to answer the request is initially identified by a photo or password which is sent electronically to the hotel room via the computer terminal 52. When the person arrives, the hotel guest, before letting the person in, can view the person through a door “peep hole” or optionally by a TV camera (not shown), to verify that the person at the door is the person identified on the computer terminal 52.

Maintenance—provides services pertaining to various hotel room maintenance problems such as dripping water faucets, need for additional towels, repair of broken or inoperative items, etc.

Housekeeping—provides services pertaining to housekeeping chores, such as cleaning, additional towels, etc.

Clubs—provides information relating to various clubs located in the hotel or clubs that are in close proximity to the hotel.

Administration—provides information pertaining to the entire establishment, thus allowing for the general observation and control of the systems activites and logs.

The second design of the multi-task, multi-location networking system 10, as shown in FIGS. 3A and 3B, performs the same functions as the first design but is implemented with fewer elements.

The central data-processing subsystem 12, as shown in FIG. 3A, is comprised of the following major elements: a first local area network LAN 14, a plurality of workstations 20, a locker data server 22 that operates in combination with a locker data disk array 24, an internet router 30, a power supply 36 and a first server 64.

The basic difference between the first design and the second design of the central data processing subsystem 12 is that the first server 64, as shown in FIG. 3B, combines into a single unit the functions performed by the central server 16, the SQL database server 18 and the combination internet information server and proxy server 28. The functions of the element 16, 18 and 28 have been previously described in the first design section and therefore are not repeated.

The remote data-processing subsystem 40, as shown in FIG. 3B, is comprised of the following major elements: an Internet service provider 42, a second LAN 44, a computer terminal 52, a power supply 54, the software 60 and a second server 66.

The basic difference between the first design and the second design of the remote data-processing subsystem 12 is that the second server 66, as shown in FIG. 3B, combines into a single unit the functions performed by the primary domain server 46, the SQL database server 48, and the combination internet information server and proxy server 50. The function of the elements 46, 48 and 50 have been previously described in the first design section and therefore are not repeated.

The software program 60, which resides in the remote data-processing subsystem 40, as shown in FIGS. 2B and 3B, is comprised of the following modules.

| | | Activation |
|---|---|---|
| Module Name | Module Description | Location |
| Startup | Starts various programs | all computer |
| | on the system according to | terminals |
| | the location of the system | |
| Logon | Allows a user to log on to the | room |
| | system and gain access to the | |
| | software and the locker data service | |
| Banner | Displays the banners and programs | room |
| | that can be displayed without | |
| | logging on | |
| Check In | Activates and deactivates the system | front desk |
| | in the room | |
| Desktop | Displays the main menu and allows a | room |
| | logged-on user to select and run programs | |
| File Mover | Allows files to be moved in and out | room |
| | of the locker data server into the | |
| | computer terminal in the room | |
| Globalink | Updates the Hotel and Globalink Data | central data- |
| Database | Base | processing |
| Update | | subsystem |
| Load | Loads all the visual basic controls | all machines |
| Controls | to the system | |
| Locker | Grants access to the logged user's | central data- |
| Access | locker data server | processing |
| | | subsystem |
| Send | Allows messages to be sent to other | all computer |
| Messages | computer terminals | terminals |
| Receive | Receives standard and emergency | all computer |
| messages | messages from other computer | terminals |
| | terminals | |
| Security | Activates and deactives the security | room |
| | system in the room | |
| Security | Views and prints messages pertinent | security |
| Station | to security matters. Also saves a | |
| | security log | |
| User | Allows the user to change their | room |
| Update | information | |
| Alarm | Set the alarm clock for a wake up call | room |
| Clock | | |
| Clubs | Ask questions about joining any clubs | room |
| | and prints an entry form at the club desk | |
| Computer | Monitors the computer terminal to check | all computer |
| Monitor | for system errors or hardware failure | terminals |
| Kitchen | Views and print requests for room service | kitchen |
| Questionnaire | Requests questioneers to be completed to | room |
| | customize the user profile | |
| Room | Orders food from room service | room |
| Service | | |
| Logoff | Logoff of the system and optionally copy | room |
| | files back to the Globalink locker | |

While the invention has been described in complete detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. A multi-task multi-location networking system adapted to operate in combination with an internet service provider to process data requested by a remotely-located users, said system comprising:
a) a central data-processing subsystem having means for receiving, processing and transmitting requested data, via the internet service provider,
b) a remote data-processing subsystem having means for allowing the remotely located user to access the requested data which is viewed on a computer terminal, and
c) a software program adapted to operate said central data-processing subsystem and said remote data-processing subsystem.

2. The system as specified in claim 1 wherein said internet service provider is Globalink Access^{SM} which is accessed by the address www.globalink.net.

3. The system as specified in claim 2 wherein the remotely-located user is located in a hotel room wherefrom the requested data is accessed and viewed on said computer terminal.

4. The system as specified in claim 3 wherein said central data-processing subsystem comprises:
a) a first local area network (LAN) having means for allowing computer terminals to share files and other elements residing in said central data-processing subsystem,
b) a plurality of workstations comprised of computer terminals that are connected to said first LAN, wherein said workstations allow an operator to connect and operate said subsystem,
c) a locker data server connected to said first LAN and which is comprised of a computer terminal which functions in combination with a locker data disk array, wherein said combination allows the locker data to be stored, accessed, and/or changed by the user,
d) a first server connected to said first LAN and having means for operating as:
(1) a central server which functions in combination with a computer terminal to provide file access for other computer terminals through said first LAN,
(2) a structured Query Language (SQL) database server which functions in combination with a computer terminal to store and administer the SQL database of said system,
(3) a combination internet information server and proxy server, wherein said servers allow both local and external users of said system to view system related web pages, and
e) an internet router that interfaces with said first server and said internet service provider, wherein said internet router connects said subsystems and routes incoming data packets to said first LAN.

5. The system as specified in claim 3 wherein said remote data-processing subsystem comprises:
a) a second local area network (LAN) having means for allowing several computer terminals to share files and other system elements residing in said remote data-processing subsystem,
b) a second server connected to said second LAN and that interfaces with said internet service provider, wherein said second server has means for operating as:
(1) a primary domain server which functions in combination with a computer terminal to provide administration over said remote data processing subsystem,
(2) an SQL database server which functions in combination with a computer terminal to store and administer the SQL database of said remote data processing system, and
(3) a combination internet information server and proxy server wherein said servers allow both local and external users of said system to view system related web pages, and
c) an information receiving computer terminal that is connected to said second LAN, wherein said computer terminal is designed to allow the user to select and receive plurality of data.

6. The system as specified in claim 5 wherein said plurality of data is comprised of:
a) rooms—provides data pertaining to services that can be accessed directly from the hotel room, such as access to the Internet, and other services provided Globalink Access^{SM},
b) front desk—provides data pertaining to future reservations, check out times, baggage help etc.,
c) room service—provides wake-up calls, food menus and ordering, laundry pick-up secretarial services, personal grooming, etc.,
d) security—provides information end administers services relating to hotel security, for example, when a hotel guest places a request for a service or to alleviate a hotel room problem, the hotel person that is to answer the request is initially identified by a photo or password which is sent electronically to the computer terminal in the guest's room. When the person arrives, the guest can view the person through a door “peep hole” or via a TV camera, to verify that the person at the door is the person identified on the computer terminal.
e) maintenance—provides services to various hotel room maintenance problems such as dripping water faucets, need for additional towels, repair of broken or inoperative items etc.

7. The system as specified in claim 6 wherein said plurality of data is further comprised of:
a) housekeeping—which provides services pertaining to housekeeping chores, such as cleaning, additional towels, etc.,
b) clubs—provides information related to various clubs located in the hotel or clubs that are located in close proximity to the hotel, and
c) administration—provides control of the entire system.

8. A multi-task, multi-location networking system adapted to operate in combination with an internet service provider to process data requested by a remotely-located users, said system comprising:
a) a central data-processing subsystem having means for receiving, processing and transmitting requested data via the internet service provider, said subsystem comprising:
(1) a first local area network (LAN) having means for allowing several computer terminals to share files and other elements residing in said central data-processing subsystem,
(2) a central server connected to said first LAN and which functions in combination with a computer terminal to provide file access for other computer terminals through said first LAN,
(3) a Structured Query Language (SQL) database server connected to said first LAN and which functions in combination with a computer terminal to store and administer the SQL database of said system,
(4) a plurality of workstations comprised of computer terminals that are connected to said first LAN, wherein said workstations allow the user to connect and use said central data-processing subsystem,
(5) a locker data server connected to said first LAN, and which is comprised of a computer terminal which functions in combination with a locker data disk array, wherein said combination allows the locker data information to be accessed, stored and/or changed by the user,
(6) a combination internet information server and proxy server having a first connection and a second connection, wherein the first connection is connected to said first LAN, wherein said servers allow both local and external users of said system to view system related web pages,
(7) an internet router having a first, second and third connection, wherein the first connection is connected to the second connection on said internet information server and proxy server, wherein said internet router connects said central data-processing subsystem to said internet service provider and routs incoming data packets to the first LAN,
(8) a web server connected to the third connection on said internet router, wherein said web server allows system related web pages to be viewed, and
(9) a news server connected to the second connection on said internet router, wherein said news server collects and disseminates current news events, weather and other newsworthy topics,
b) a remote data-processing subsystem having means for allowing the remotely located users to access the requested data which is viewed on a computer terminal, said subsystem comprising:
(1) a second local area network (LAN) having means for allowing several computer terminals to share files and other system files residing in said remote data processing subsystem,
(2) a primary domain server connected to said second LAN and which functions in combination with a computer terminal to provide administration over said remote data processing subsystem,
(3) an SQL database server connected to said second LAN and which functions in combination with a computer terminal to store and administer the SQL database of said remote data processing subsystem,
(4) a combination internet information server and proxy server having a first connection connected to said second LAN and which also interfaces with said internet service provider, wherein said servers allow system related web pages to be viewed,
(5) an information receiving station comprised of a computer terminal that is connected to said second LAN, wherein said computer terminal is designed to allow the user to select and receive a plurality of data, and
c) a software program adapted to operate in combination with said central data-processing subsystem and said remote data-processing subsystem.

9. The system as specified in claim 8 wherein each said workstation is comprised of a microcontroller having at least 32 megabytes of RAM, 2 gigabytes of hard disk capacity, a screen with graphics resolution of at least 800×600 pixel and an operating system such as UNIX.

10. The system as specified in claim 8 wherein the remotely-located user is are located in a hotel room wherefrom the selectable information is accessed and viewed on said computer terminal.

11. The system as specified in claim 10 wherein said plurality of data is comprised of:
a) rooms—provides data pertaining to services that can be accessed directly from the hotel room, such as access to the Internet, and other services provided Globalink Access^{SM},
b) front desk—provides data pertaining to future reservations, check out times, baggage help etc.,
c) room service—provides wake-up calls food menus and ordering, laundry pick-up secretarial services, personal grooming, etc.,
d) security—provides information end administers services relating to hotel security, for example, when a hotel guest places a request for a service or to alleviate a hotel room problem, the hotel person that is to answer the request is initially identified by a photo or password which is sent electronically to the computer terminal in the guest's room. When the person arrives, the guest's can view the person through a door “peep hole” or via a TV camera, to verify that the person at the door is the person identified on the computer terminal, and
e) maintenance—provides services to various hotel room maintenance problems such as dripping water faucets, need for additional towels, repair of broken or inoperative items etc.

12. The system as specified in claim 10 wherein said plurality of data is further comprised of:
a) housekeeping—which provides services pertaining to housekeeping chores, such as cleaning, additional towels, etc.,
b) clubs—provides information related to various clubs located in the hotel or clubs that are located in close proximity to the hotel, and
c) administration—provides control of the entire system.

13. The system as specified in claim 8 wherein said computer terminals operate on Windows NT.

14. The system as specified in claim 8 wherein said first and second LANS's comprise an Ethernet network that provides communication by means of radio frequency signals carried by a coaxial cable.

15. The system as specified in claim 14 wherein said Ethernet operates on a broadband which modulates the Ethernet signal on a higher-frequency carrier to allow several signals to be carried simultaneously on a single coaxial cable.

16. The system as specified in claim 8 wherein said central server, said SQL database server, said combination internet information server and proxy server, said web server, and said news server as used in said central data-processing subsystem are comprised of a single unit.

17. The system as specific in claim 8 wherein said primary domain server, said SQL database server, and said internet information server and proxy server, as used in said remote data processing subsystem, are comprised of a single unit.

18. The system as specified in claim 8 wherein said web server and said news server operate on a Unix system.

19. The system as specified in claim 8 wherein said software program is comprised of the following passive and interactive modules:
a) startup,
b) logon,
c) check in,
d) desktop,
e) Globalink database update,
f) load controls,
g) send messages,
h) receive messages,
i) security,
j) security station,
k) user update, and
l) logoff.

20. The system as specified in claim 8 wherein said software is further comprised of the following optional modules:
a) alarm clock,
b) clubs,
c) computer monitor,
d) kitchen
e) questionnaire,
f) room service,
g) banner
h) file mover, and
i) locker access.
